(19) United States
(12) Patent Application Publication
(10) Pub. No.: US 2016/0113827 A1
(43) Pub. Date: Apr. 28, 2016

(54) The CHAIR-iot

(71) Applicant: Lisa Tahir, New Orleans, LA (US)

(72) Inventor: Lisa Shawn Tahir, New Orleans, LA (US)

(21) Appl. No.: 14/055,885

(22) Filed: Jan. 2, 2014

(51) Int. Cl. A61G 5/10; E04B 1/348; B25H 1/02

(52) U.S. Cl. CPC A61G 5/10; B25H 1/02; E04B 1/348; A61G 2005/1094

(57) ABSTRACT

Example embodiments of the workbench for wheelchair disclosed herein allow participants to stay in their existing wheelchair without having to transfer to another seat or work bench. This ensures that they are comfortable and safe. The bench may be constructed of steel and the sides may be raised or lowered to ensure the proper height. An example embodiment includes a detachable side tool bench, which may be raised or lowered to the proper height for the participant in a wheelchair to access the needed tools to shape the glass.

### CROSS REFERENCE TO RELATED APPLICATIONS

This application is related to U.S. Design application Ser. No. 29/470,017, filed on Oct. 17, 2013, which is incorporated by reference herein.

### TECHNICAL FIELD

The present disclosure is generally related to furniture and, more particularly, is related to a workbench for a wheelchair.

### BACKGROUND

Glassblowing is a glassforming technique that involves inflating molten glass into a bubble (or parison), with the aid of a blowpipe (or blow tube). A person who blows glass is called a glassblower, glassmith, or gaffer.

The major tools used by a glassblower are the blowpipe (or blow tube), punty (or punty rod, pontil, or mandrel), marver, blocks, jacks, paddles, tweezers, paper, a variety of shears, and a bench.

The tip of the blowpipe is first preheated; then dipped in the molten glass in the furnace. The molten glass is “gathered” onto the end of the blowpipe in much the same way that viscous honey is picked up on a honey dipper. This glass is then rolled on the marver, which was traditionally a flat slab of marble, but today is more commonly a fairly thick flat sheet of steel. This process, called marvering, forms a cool skin on the exterior of the molten glass blob, and shapes it. Then air is blown into the pipe, creating a bubble. Next, the glassworker can gather more glass over that bubble to create a larger piece. Once a piece has been blown to its approximate final size, the bottom is finalized. Then, the molten glass is attached to a stainless steel or iron rod called a punty for shaping and transferring the hollow piece from the blowpipe to provide an opening and/or to finalize the top.

Blocks are ladle-like tools made from water-soaked fruitwood, and are used similarly to the marver to shape and cool a piece in the early steps of creation. Jacks are tools shaped somewhat like large tweezers with two blades, which are used for forming shape later in the creation of a piece. Paddles are flat pieces of wood or graphite used for creating flat spots such as a bottom. Tweezers are used to pick out details or to pull on the glass. Straight shears are essentially bulky scissors, used for making linear cuts. Diamond shears have blades that form a diamond shape when partially open. These are used for cutting off masses of glass.

The bench is a glassblower's workstation, and generally comprises a place for the glassblower to sit, a place for the handheld tools, and two rails that the pipe or punty rides on while the blower works with the piece. There are heretofore unaddressed needs with previous bench solutions.

### SUMMARY

Example embodiments of the present disclosure provide a workbench for wheelchair. Briefly described, in architecture, one example embodiment of the workbench, among others, can be implemented as follows: a first side with a posterior portion at a first height and an anterior portion at a second, higher height; a second side with a posterior portion at a third height and an anterior portion at a fourth, higher height; and a cross member connecting the first side and the second side, the cross member setting the distance between the first side and the second side as wide enough to accept a wheel chair

### BRIEF DESCRIPTION OF THE DRAWINGS

FIG. 1 is a perspective diagram of an example embodiment of a workbench for wheelchair.

FIG. 2 is a perspective diagram of an example embodiment of a side of the workbench of FIG. 1.

FIG. 3 is a perspective diagram of an example embodiment of the workbench of FIG. 1.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the workbench for wheelchair assists people in wheelchairs perform the functions of casting and blowing hot glass. Previously, in a glassblowing facility, a handicapped/wheelchair bound person must leave the wheelchair and move to the glassblowing bench. Not only is this inconvenient, but the potential for injury exists. There is no previously designed wheelchair accessible work bench by which someone in a wheelchair could blow or cast glass and be safe. Example embodiments of the workbench for wheelchair disclosed herein allows participants to stay in their existing wheelchair without having to transfer to another seat or work bench. This ensures that they are comfortable and safe. The bench may be constructed of steel and the sides may be raised or lowered to ensure the proper height. An example embodiment includes a detachable side tool bench, which may be raised or lowered to the proper height for the participant in a wheelchair to access the needed tools to shape the glass.

A glass casting and blowing instructor may assist the participant in the wheelchair just as with a non-disabled participant. The benefit for the disabled participant is the learning of a new skill that may result in increased income if the participant sells their glass art pieces and it promotes emotional well-being, happiness, and an increased quality of life as reported by The American Art Therapy Association and The National Arts and Disability Center.

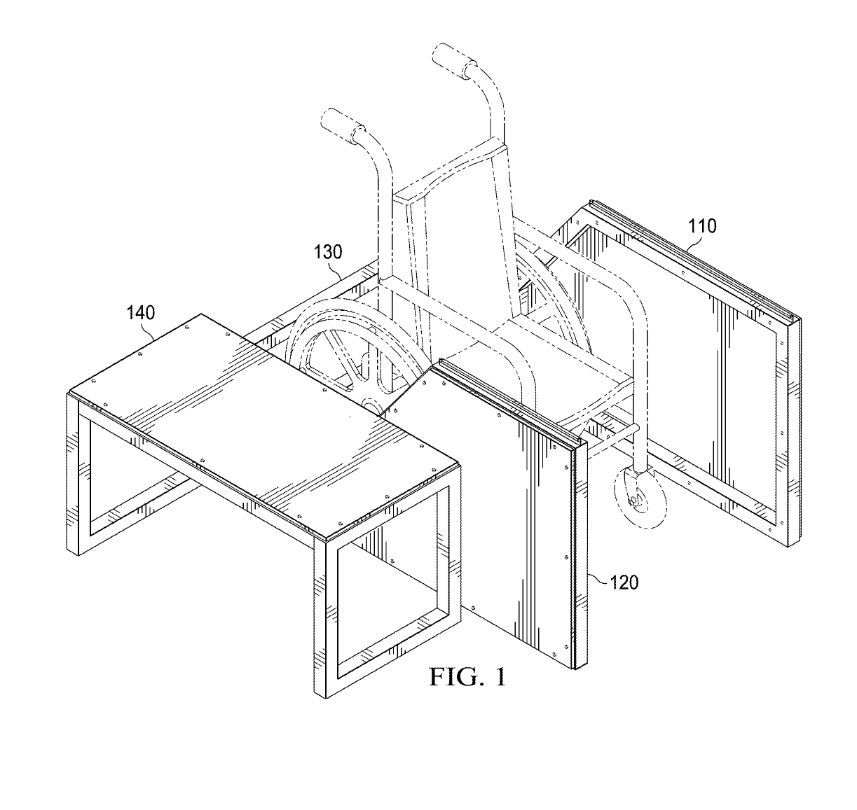

FIG. 1 provides a perspective view of an example embodiment of a workbench for a wheelchair as disclosed herein. The workbench comprises first side 110, second side 120, crossbar 130, and detachable side bench 140. Crossbar 130 establishes the distance between first side 110 and second side 120. The heights of first side 110 and second side 120 may be adjustable for the comfort and utility of the wheelchair participant and/or the instructor/assistant. Side bench 140 may also be adjustable for the benefit of the wheelchair participant. Side bench 140 may attach to either first side 110 or second side 120.

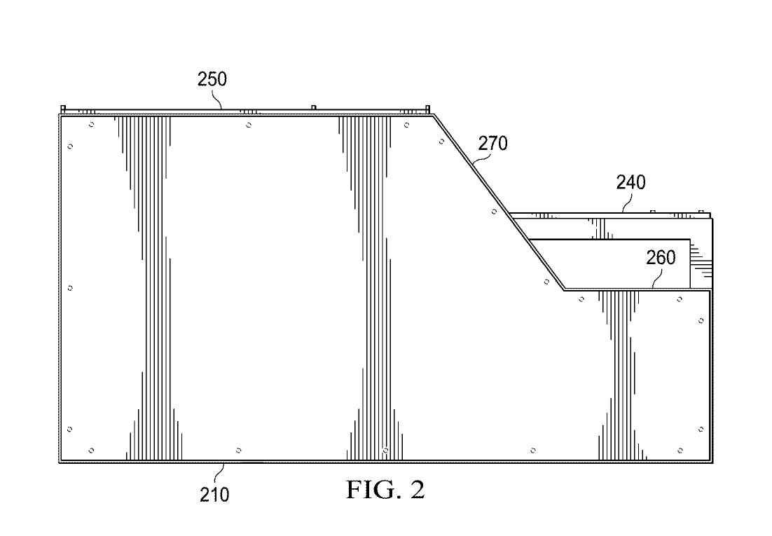

FIG. 2 provides a side view of an example embodiment of first side 210. First side 210 comprises anterior portion 250, posterior portion 260, and connecting portion 270. The height of anterior portion 250 may adjustable and may be set for ease of the user in performing his glass blowing functions. posterior portion 260 may be set lower than anterior portion 250, to allow the wheelchair participant easy access to side bench 240. Connecting portion 270 connects anterior portion 250 and posterior portion 260. Connecting portion 270 may be slanted (at various angles) as shown in FIG. 2. The second side is similarly constructed.

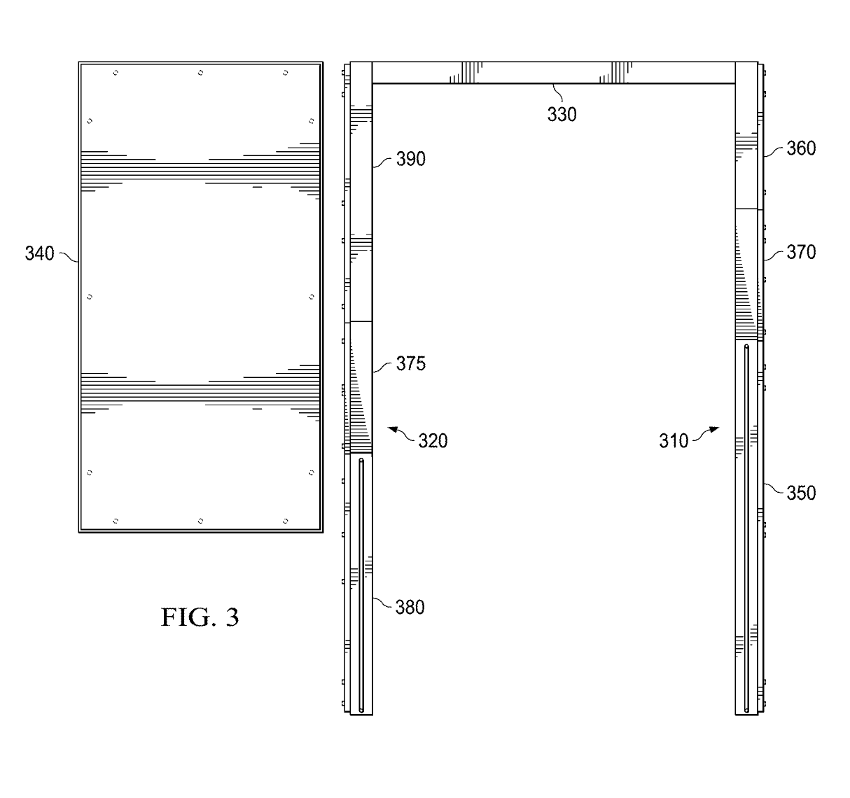

FIG. 3 provides an overhead view of an example embodiment of a workbench for wheelchair as disclosed herein, including first side 310, second side 320, cross member 330, and detachable side table 340. First side 310 comprises first anterior portion 350, first posterior portion 360, and first connecting portion 370. Second side 320 comprises second anterior portion 380, second posterior portion 390, and second connecting portion 375.

Although the present disclosure has been described in detail, it should be understood that various changes, substitutions and alterations can be made thereto without departing from the spirit and scope of the disclosure as defined by the appended claims.

Therefore, at least the following is claimed:

1. (canceled)

2. An apparatus comprising:
a first side with a first posterior portion at a first height and a first anterior portion at a second, higher height;
a second side with a second posterior portion at a third height and a second anterior portion at a fourth, higher height; and
a cross member connecting the first side and the second side, the cross member setting the distance between the first side and the second side as wide enough to accept a wheel chair.

3. The apparatus of claim 2, further comprising a detachable table, the detachable table accessible for a wheelchair participant over either the first posterior portion or the second posterior portion.

4. The apparatus of claim 2, wherein the first height and the third height are substantially similar and the second height and the fourth height are substantially similar.

5. The apparatus of claim 2, wherein the first anterior portion and the second anterior portion are adjustable to facilitate glassblowing by a wheelchair participant.

6. The apparatus of claim 2, wherein the first posterior portion and the second posterior portion are adjustable to facilitate access to a detachable table by a wheelchair participant.

7. The apparatus of claim 2, wherein the first anterior portion and the second anterior portion are different lengths.
